(19) United States
(12) Patent Application Publication
(10) Pub. No.: US 2012/0303322 A1
(43) Pub. Date: Nov. 29, 2012

(54) INCORPORATING MEMORY AND IO CYCLE INFORMATION INTO COMPUTE USAGE DETERMINATIONS

(76) Inventors: Charles W. Rego, Dupont, WA (US); Nishi Ahuja, University Place, WA (US); Jay L. Vincent, Folsom, CA (US); Mrittika Ganguli, Bangalore (IN); Thanunathan Rangarajan, Bangalore (IN); Jaiber J. John, Bangalore (IN)

(21) Appl. No.: 13/113,771

(22) Filed: May 23, 2011

(51) Int. Cl. G06F 15/00

(52) U.S. Cl. 702/182

(57) ABSTRACT

A system and method provide for receiving data corresponding to a computing node and identifying a processor usage, a memory usage and an input/output (IO) usage based at least in part on the data corresponding to the computing node. In addition, a compute usage value may be determined for the computing node based at least in part on the processor usage, the memory usage and the IP usage.

### BACKGROUND

1. Technical Field

Embodiments generally relate to computing systems. More particularly, embodiments relate to the incorporation of memory and input/output (IO) cycle information into compute usage determinations.

2. Discussion

In cloud computing environments, the workloads being executed on data center servers may tend to be temporary and transient based on user demand, wherein effective management of a cloud computing environment can be dependent on the ability to determine the computing capacity of the servers involved. In addition, in high performance computing (HPC) environments, the infrastructure computing capacity can be particularly relevant to capacity planning, load optimization, threshold based workload scheduling and compute performance service level agreements (SLAs).

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a virtual machine allocation according to an embodiment;

FIG. 2 is a block diagram of an example of a job scheduling technique according to an embodiment;

FIG. 3 is a screenshot of an example of a set of compute usage plots according to an embodiment;

FIG. 4 is a block diagram of an example of a load balancing architecture according to an embodiment;

FIG. 5 is a flowchart of an example of a method of scheduling activities according to an embodiment;

FIG. 6 is a block diagram of an example of a data collection framework according to an embodiment; and

FIG. 7 is a block diagram of an example of a compute usage management console according to an embodiment.

### DETAILED DESCRIPTION

Embodiments may include a computer readable storage medium having a set of central node instructions which, if executed by a processor, cause a computer to receive data corresponding to a computing node, and identify a processor usage, a memory usage and an input/output usage based at least in part on the data corresponding to the computing node. The instructions may also cause a computer to determine a compute usage value for the computing node based at least in part on the processor usage, the memory usage, and the input/output usage.

Other embodiments can include a system having a processor and a computer readable storage medium with a set of central node instructions which, if executed by the processor, cause the system to receive data corresponding to a computing node. The instructions may also cause the system to identify a processor usage, a memory usage and an input/output usage based at least in part on the data corresponding to the computing node, and determine a compute usage value for the computing node based at least in part on the processor usage, the memory usage and the input/output usage.

In addition, embodiments may include a computer readable storage medium having a set of agent instructions which, if executed by a processor, cause a computer to collect data corresponding to a computing node, wherein the data is to be associated with a processor usage, a memory usage and an input/output usage. The instructions can also cause a computer to send the data to a compute usage calculation node (e.g., central node).

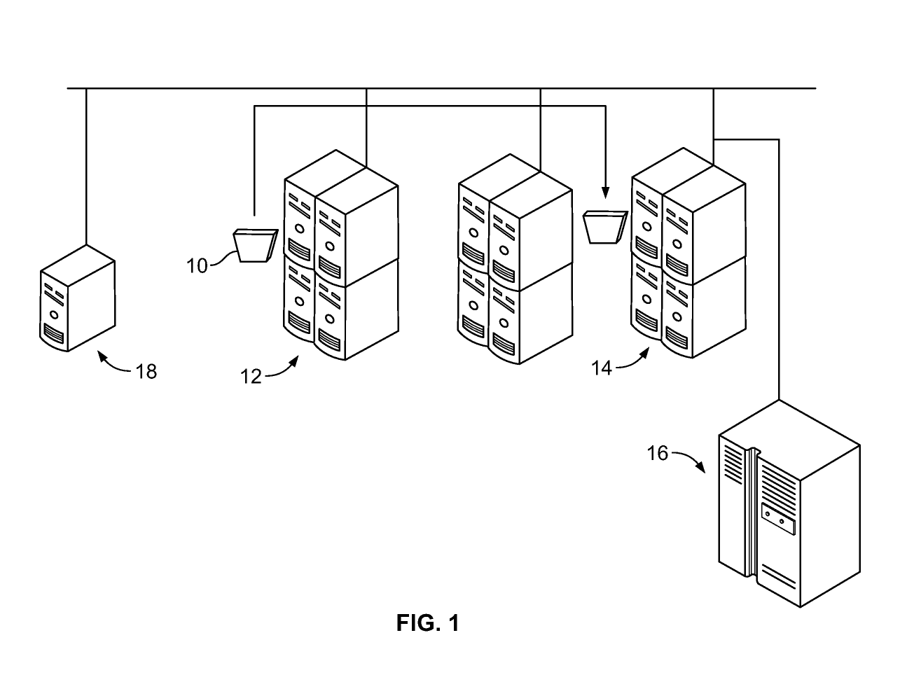

Turning now to FIG. 1, a scenario is shown in which a compute usage (e.g., compute usage per second/CUPS) value is determined for a virtual machine (VM) 10 originally associated with a first set of servers 12. As will be discussed in greater detail, the compute usage value determination can take into consideration processor usage, memory usage, input/output (IO) usage, and so on. In the illustrated example, the VM 10 runs a workload that transitions to a state involving a relatively high amount of memory usage. Because the compute usage value determination can take into consideration memory usage (as well as processor usage, IO usage, etc.), a decision may be made to transfer the VM 10 to a second set of servers 14 having a high capacity storage node 16. The decision to move the VM 10 could be made by a management station 18 running central node logic, or by another suitable computing platform.

Thus, the illustrated example might be used in cloud computing or high performance computing (HPC) environments to enhance capacity planning, load optimization, threshold based workload scheduling, compute performance service level agreements (SLAs), etc., for temporary and/or transient workloads. Indeed, a single compute usage value can be used to conduct each of the aforementioned functions for workloads even as workloads change from being processor-to-memory intensive, memory-to-IO intensive, IO-to-processor intensive, and so on. For example, a particular web workload having a relatively high network bandwidth usage during a user interactive phase could be transferred to another computing node during a pricing calculation phase that has a relatively high processor usage component.

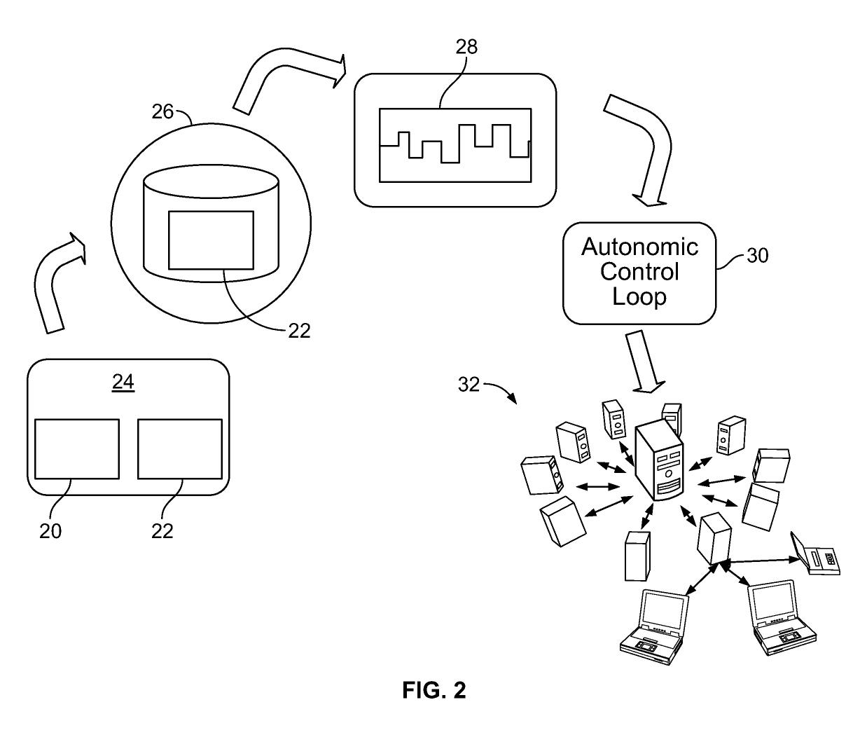

FIG. 2 shows a job scheduling technique in which an HPC interface 24 supports the execution of a first application type 20 and a second application type 22. In the illustrated example, the second application type 22 is part of a workload associated with a computing node 26. During execution of the second application type 22, data corresponding to the computing node 26 may be collected, wherein the collected data is associated with processor usage, memory usage and IO usage for the computing node 26. A compute usage value metric 28 may be generated based on the collected data, wherein the compute usage value metric 28 is used to invoke an autonomic control loop 30, in the example shown. The autonomic control loop 30 might involve an iterative monitor-decide-action process that enables the job/workload to be allocated to the most appropriate computing node in a cloud 32 of computing resources.

The illustrated approach to measuring the compute usage value metric 28 may therefore enable “useful work” to be defined via an active mode periodic sampling subsystem for both virtual and native environments. As already noted, the compute usage value metric 28 can be determined based on numerous factors such as processor usage, memory usage, and JO usage (both network and disk). For example, a compute usage per second (CUPS) metric might be defined as follows.

Compute_usage=Fn{CPU+Memory+IO(Network,Storage)} (1)

Moreover, a data collection framework may be provided in which agents in the operating system (OS)/virtual machine monitor (VMM) of one or more computing nodes collects processor, memory and JO usage data. In one example, the data collection is implemented by sampling various performance monitor (perfmon) counters and/or hardware registers on a configurable timeline. Application program interfaces (APIs) may also be used as interfaces between the data collection framework and management applications and/or job scheduling frameworks. In particular, the expression below can be used to represent the CUPS determination for a virtual machine and for a computing node associated with a plurality of virtual machines, respectively.

$$\begin{matrix}{CUPS}_{vm} = [ \frac{( \frac{{CPU}_{curr}}{{CPU}_{max}} ) + ( \frac{{MEM}_{curr}}{{MEM}_{max}} ) + ( \frac{{IO}_{curr}}{{IO}_{max}} ) + {\sum }_{i = 1}^{n} \frac{{TRACE}_{proto ( i )}}{{TRACE}_{total}}}{Interval \times Capacity} ] \times Const \\ and , 0 \leq C U P S \leq 100 & ( 2 ) \\ {CUPS}_{node} = {\sum }_{i = 0}^{N} {CUPS}_{vm ( i )} & ( 3 )\end{matrix}$$

Where, CPU_{curr}=current CPU usage, CPUₘₐₓ=CPU maximum cycle count, MEM_{curr}=current memory usage or L2 (level 2) cache hits, MEMₘₐₓ=maximum memory, IO_{curr}=current JO byte reads and writes, IOₘₐₓ=maximum IO, TRACE_{protoco(i)}=IO trace packets for protocol i (i.e., network JO usage on a per network protocol basis), TRACEₜₒₜₐₗ=total JO trace packets for all network protocols, n is the number of network protocols, Interval is the data collection sampling interval, Capacity is the resource capacity of the computing node, and N is the number of virtual machines in the computing node. Given the following resource ranges,

TABLE 1
Resource Range Information

CPU

| Type | Cores | Threads | Cycle Speed | Maximum |
|---|---|---|---|---|
| | 8 | 16 | 100 | (CS * T) = 1600 |

Memory

| | Size/DIMM | Bandwidth | |
|---|---|---|---|
| DIMMs | (MB) | (rw/s) | |
| 4 | 500 | 80 | DIMMS * size * BW = |
| | | | 40000 |

IO-Disk

| | Capacity used | R/W speed | |
|---|---|---|---|
| Size (bytes) | (bytes) | (bytes/s) | |
| 80000 | 40000 | 40 | (s − CU) * RW = |
| | | | 160000 |

IO-Network

| Speed/Bandwidth | Cache Size |
|---|---|
| . . . | . . . |

Capacity (based on the example in Table 1) might therefore be defined in the following manner (e.g., CPU utilization %/CPU Max %=CPU useable work).

TABLE 2
Capacity Formulation Based on Resource Range

| CPU | Mem (MB²/s) | Disk (B²/s) | Capacity |
|---|---|---|---|
| ≦1600 | ≦20K | ≦100K | 1 |
| 1601-2000 | 20001-40K | 100001-200K | 2 |
| . . . | . . . | . . . | 3 |

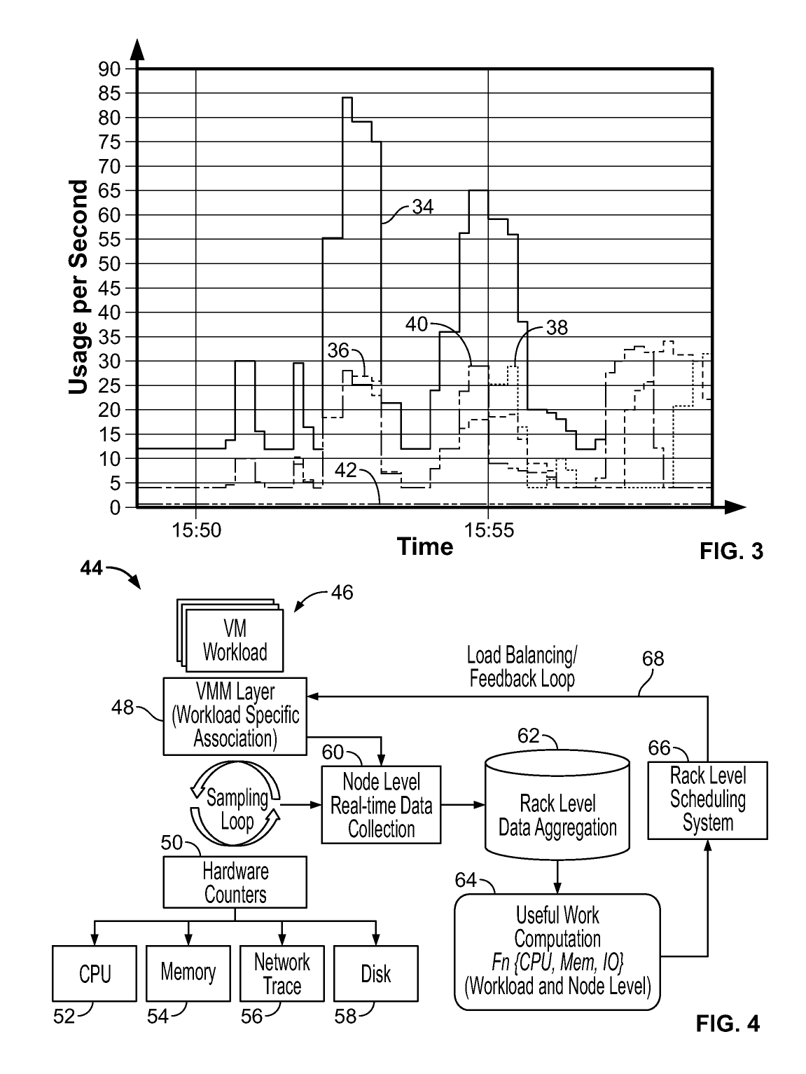

Turning now to FIG. 3, a set of compute usage plots is shown for a cluster of virtual machines. In particular, a ten minute sample contains information for a total CUPS plot 34, as well as CUPS plots 36, 38 and 40 for specific workloads running on virtual machines (e.g., VM1, VM2, VM3, respectively) of a computing node. In addition, the CUPS value of the virtual machine monitor (VMM or domain zero/DOMO) is shown as a baseline plot 42. Deeper analysis of the CUPS values of each workload shows time periods in which one or more CUPS values are significantly lower. Thus, recording the type of computation or IO activity at the application level may enable the VMM scheduler to be tuned further.

FIG. 4 shows a CUPS subsystem 44 for a computing node that executes a set of VM workloads 46. In the illustrated example, a VMM layer 48 uses a sampling loop to read one or more hardware counters 50 and/or registers and obtain CPU usage data 52, memory usage data 54, network trace (e.g., network IO usage) data 56, disk IO usage data 58, etc. Workload specific associations and the collected data may be sent to a node level real-time data collection module 60, which can send the information to a rack level data aggregation node 62. The aggregated data is used by a compute usage calculation module/node 64 to determine one or more compute usage values for the computing nodes involved, in the example shown. In particular, the compute usage values may be determined at the workload level as well as at the node level, and can be sent to a rack level scheduling system 66. A feedback loop 68 to the VMM layer may support enhanced capacity planning, load optimization, threshold based workload scheduling and SLA management.

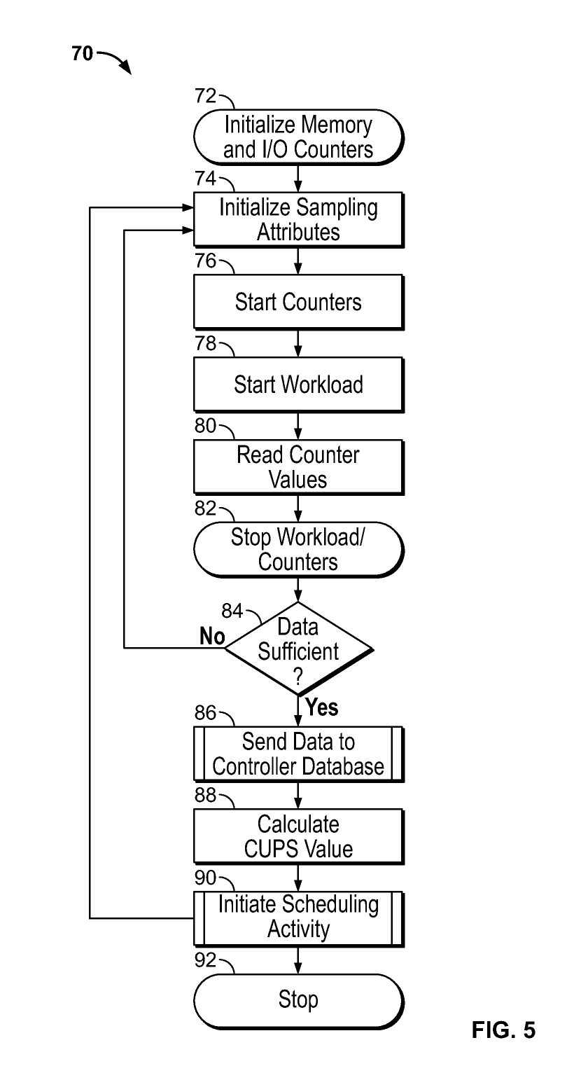

Turning now to FIG. 5, a method 70 of scheduling activities is shown. The illustrated method 70 may be implemented in executable software as a set of firmware logic instructions stored in a machine or computer readable storage medium of a memory such as, for example, programmable read only memory (PROM), ROM, random access memory (RAM), flash memory, etc., in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 70 may be written in any combination of one or more programming languages, including an object oriented programming language such as Java, Smalltalk, C++ or the like and conventional procedural programming languages, such as the “C” programming language or similar programming languages. On the other hand, fixed-functionality hardware or lower-level instructions such as assembly language programming or machine code might be used to carry out operations shown in the method 70.

Processing block 72 provides for initializing one or more memory and IO counters of a computing node. As already noted, the counters may provide useful data in the compute usage value determination process. In one example, the following Intel® specific perfmon (un-core and chipset) counters might be initialized in block 72: fixed function counters (MSR_PERF_FIXED_CTR[0-1]); programmable counters (MSR_UNCORE_PMC[0-2]); un-core counters (MSR_UNCORE_FIXED_CTR0); and chipset counters—XP cluster (XP_PMR0_REG, XP_MR1_REG). Simply put, the initialized counters can contain memory and IO cycle information that may be used to identify processor usage, memory usage, and IO usage for the computing node. Block 74 provides for initializing sampling attributes (e.g., sampling frequency/interval), wherein the initialized counters may be started at block 76. Block 78 provides for starting one or more workloads, and the counter values may be read at block 80. The workload and counters can be stopped at block 82, wherein illustrated block 84 determines whether a sufficient amount of data has been collected. If not, the data collection process may be repeated.

If a sufficient amount of data has been collected, illustrated block 86 provides for sending the collected data to a central node controller database (e.g., compute usage calculation node). A CUPS value may be calculated at block 88 based at least in part on the processor usage, memory usage and IO usage reflected in the collected data. Illustrated block 90 initiates one or more scheduling activities (e.g., workload allocation) based on the calculated CUPS value, wherein the routine may terminate at block 92.

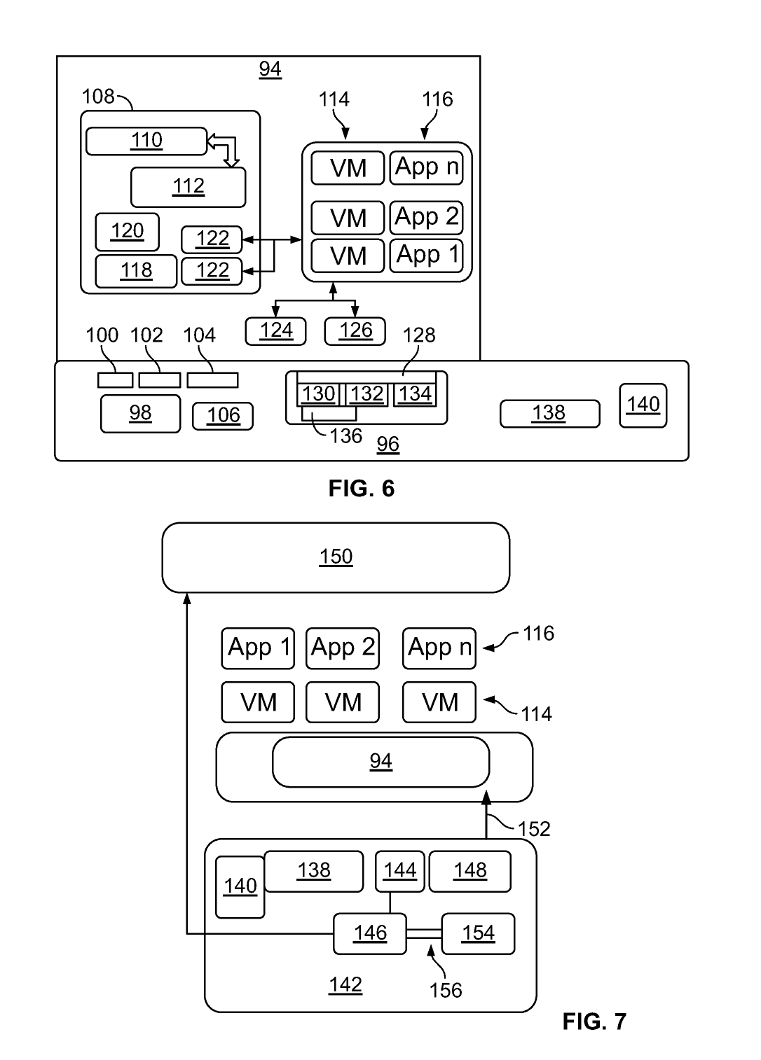

FIG. 6 shows a particular data collection framework in which a CUPS agent 94 uses various system level tools and hardware counters to accurately determine various compute usage aspects—including processor usage, memory usage and IO usage—of virtual machines 114 and associated applications 116 running on a computing node. The framework may be implemented in a fixed platform computing node such as a PC, server, workstation, etc., or in a mobile platform computing node such as a laptop, personal digital assistant (PDA), mobile Internet device (MID), tablet, wireless smart phone, media player, imaging device, etc. Thus, each computing node in a cloud 32 (FIG. 2) of computing resources might use a CUPS agent 94 to collect the metrics of multiple VMs and send the collected metrics to a central controller node such as a management station 18 (FIG. 1) for further processing.

In the illustrated example, the computing node in question includes a controller 96 such as a baseboard management controller (BMC) and/or a manageability engine (ME). The controller 96 may also have one or more performance monitor counters 98 and/or model specific registers (MSRs, not shown) configured to track processor usage 100, memory usage 102 and IO usage 104, wherein the counters 98 may be accessed via a bus 106 such peripheral components interconnect (PCI) bus.

In addition, domain zero (Dom0, e.g., the first guest OS in a virtual environment) 108, includes a data center management plug-in 110 (e.g., SourceForge Ganglia plug-in) that interfaces with a data collection agent 112 in a standard operating system (OS) environment (e.g., Windows®) or in the privileged domain of a VMM. The data collection agent 112 may use drivers and/or system libraries to periodically collect data from the performance monitor counters 98 and MSRs. A hypervisor (e.g., VMM) stack (e.g., Xentrace/Xenmon) 118 can also be used to conduct system data collection. In particular, the illustrated CUPS agent 94 also uses an IO trace engine 120 to observe per-VM network traffic at one or more shared links 122 (e.g., bridges, virtual block drivers), perform shallow packet inspection, and determine the dominant protocol being used by the running application. The classifications conducted by the IO trace engine 120 can help in characterizing the type of application 116 transmitting or receiving the packets as well as the VM 114 involved.

The illustrated CUPS agent 94 interfaces with the controller 96 via a virtual CPU interface (VCPU) 124 and/or manageability engine (ME) interface 126. In addition, the controller 96 may include a management interface 128 such as an intelligent platform management interface (IPMI) and/or a data center manageability interface (DCMI) in order to obtain data such as air flow data 130, in/out temperature data 132, thermal margin data 134, power data 136, etc., which may all be used with the CUPS value for enhanced platform management. The illustrated controller 96 also includes basic input/output system (BIOS) memory 138 and a network interface controller (NIC) 140. The NIC 140 could provide off-platform communication functionality for a wide variety of purposes such as, for example, cellular telephone (e.g., W-CDMA (UMTS), CDMA2000 (IS-856/IS-2000), etc.), WiFi (e.g., IEEE 802.11, 1999 Edition, LAN/MAN Wireless LANS), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), and other radio frequency (RF) telephony purposes. The NIC 140 might also use a wired data connection (e.g., RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification), digital subscriber line (DSL), cable modem, T1 connection), etc., to enable access to additional off-platform resources.

FIG. 7 demonstrates that a computing node such as a server 142 may have a baseboard management controller (BMC) 146 and a manageability engine (ME) 144 that determine a CUPS value 148 and provides the CUPS value 148 to an out-of-band (OOB) management console 150. Thus, the BMC 146 and ME 144 may function similarly to the controller 96 (FIG. 6) already discussed. In the illustrated example, the ME 144 communicates with one or more CUPS agents 94 via an interface 152 (e.g., host embedded controller interface/HECI) on a per VM/process basis to obtain data associated with processor usage, memory usage, IO usage, capacity, etc. The BMC 146 may also communicate with a CPU 154 of the server 142 via an interface 156 such as a platform environment control interface (PECI).

Thus, in the illustrated example, the CUPS agent 94 includes logic to collect data corresponding to the server 142, wherein the data is to be associated with processor usage, memory usage, IO usage, and so on. The CUPS agent 94 logic may also send the collected data to a compute usage calculation node such as the ME 144 via the interface 152. Additionally, the illustrated ME 144 includes logic to receive the data corresponding to the server 142, and identify the processor usage, the memory usage and the IO usage based at least in part on the received data. The ME 144 may also determine a compute usage value (e.g., CUPS value) for the server 142 based at least in part on the processor usage, the memory usage and the IO usage. Moreover, in a virtualized environment, the ME 144 can determine a compute usage value for each of the VMs 114 associated with the server 142 to obtain a plurality of compute usage values. In such a case, the ME 144 might determine the compute usage value for the server 142 based at least in part on the plurality of compute usage values. In addition, the ME 144, BMC 146 and/or management console 150 may allocate one or more workloads based at least in part on the compute usage value for the server 142.

Thus, techniques described herein enable HPC job allocation software and/or management applications to consider more than compute cycles used by CPUs alone—by accounting for memory and IO cycles, the techniques can provide a comprehensive representation of energy efficiency in data centers using a single metric. Moreover, the unique compute usage value may serve as a trigger for a higher level management system to initiate rack-level optimizations and decisions. The approaches described herein might therefore be used to enhance the features of software that manages compute resources and plan capacity, as well as to manage air conditioning and power distribution based on computing system workloads.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size may be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention may be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. might be used herein only to facilitate discussion, and carry no particular temporal or chronological significance unless otherwise indicated.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer readable storage medium comprising a set of instructions which, if executed by a processor, cause a computer to:
receive data corresponding to a computing node;
identify a processor usage, a memory usage and an input/output usage based at least in part on the data corresponding to the computing node; and
determine a compute usage value for the computing node based at least in part on the processor usage, the memory usage and the input/output usage.

2. The medium of claim 1, wherein the instructions, if executed, cause a computer to:
determine a compute usage value for each of a plurality of virtual machines associated with the computing node to obtain a plurality of compute usage values; and
determine the compute usage value for the computing node based at least in part on the plurality of compute usage values.

3. The medium of claim 1, wherein the data corresponding to the computing node is to include at least one of register data and hardware counter data.

4. The medium of claim 1, wherein the input/output usage is to include a network input/output usage.

5. The medium of claim 4, wherein the network input/output usage is to be determined on a per network protocol basis.

6. The medium of claim 1, wherein the input/output usage is to include a disk input/output usage.

7. The medium of claim 1, wherein the instructions, if executed, cause a computer to allocate a workload based at least in part on the compute usage value.

8. A system comprising:
a processor; and
a computer readable storage medium including a set of instructions which, if executed by the processor, cause the system to,
receive data corresponding to a computing node,
identify a processor usage, a memory usage and an input/output usage based at least in part on the data corresponding to the computing node, and
determine a compute usage value for the computing node based at least in part on the processor usage, the memory usage and the input/output usage.

9. The system of claim 8, wherein the instructions, if executed, cause the system to:
determine a compute usage value for each of a plurality of virtual machines associated with the computing node to obtain a plurality of compute usage values, and
determine the compute usage value for the computing node based at least in part on the plurality of compute usage values.

10. The system of claim 8, wherein the data corresponding to the computing node is to include at least one of register data and hardware counter data.

11. The system of claim 8, wherein the input/output usage is to include a network input/output usage.

12. The system of claim 11, wherein the network input/output usage is to be determined on a per network protocol basis.

13. The system of claim 8, wherein the input/output usage is to include a disk input/output usage.

14. The system of claim 8, wherein the instructions, if executed, cause the system to allocate a workload based at least in part on the compute usage value.

15. A computer readable storage medium comprising a set of instructions which, if executed by a processor, cause a computer to:
collect data corresponding to a computing node, wherein the data is to be associated with a processor usage, a memory usage and an input/output usage; and
send the data to a compute usage calculation node.

16. The medium of claim 15, wherein the instructions, if executed, cause a computer to:
collect data for each of a plurality of virtual machines associated with the computing node to obtain a set of data; and
send the set of data to the compute usage calculation node.

17. The medium of claim 15, wherein the instructions, if executed, cause a computer to read one or more registers to obtain the data corresponding to the computing node.

18. The medium of claim 15, wherein the instructions, if executed, cause a computer to read one or more hardware counters to obtain the data corresponding to the computing node.

19. The medium of claim 15, wherein the input/output usage is to include a network input/output usage on a per network protocol basis.

20. The medium of claim 15, wherein the input/output usage is to include a disk input/output usage.
